(19) United States
(12) Patent Application Publication
(10) Pub. No.: US 2019/0266436 A1
(43) Pub. Date: Aug. 29, 2019

(54) MACHINE LEARNING IN AN IMAGING MODALITY SERVICE CONTEXT

(71) Applicant: General Electric Company, Schenectady, NY (US)

(72) Inventors: Prakhar Prakash, Waukesha, WI (US); John Moore Boudry, Waukesha, WI (US)

(21) Appl. No.: 15/905,520

(22) Filed: Feb. 26, 2018

(51) Int. Cl. G06K 9/46; G06N 3/08; G06K 9/66; G06T 7/10

(52) U.S. Cl. CPC G06K 9/4628; G06N 3/08; G06T 2207/20081; G06T 7/10; G06T 2207/20084; G06K 9/66

(57) ABSTRACT

The present approach relates to detection of image artifacts symptomatic of needed calibration and/or failing hardware with no or limited human intervention, such as using machine learning. Detection of image artifacts can occur as part of normal imaging system operation and/or as part of a quality assessment of a newly manufactured or already installed system. Detection of image artifacts can adapt or learn as new scans are acquired using supervised or semi-supervised learning. Assessment of system imaging performance in the recently manufactured as well as the installed base can be performed reliably and automatically.

### TECHNICAL FIELD

The subject matter disclosed herein relates to determining service needs of imaging systems using of machine learning techniques.

### BACKGROUND

Non-invasive imaging technologies allow images of the internal structures or features of a patient/object to be obtained without performing an invasive procedure on the patient/object. In particular, such non-invasive imaging technologies rely on various physical principles (such as the differential transmission of X-rays through a target volume, the reflection of acoustic waves within the volume, the paramagnetic properties of different tissues and materials within the volume, the breakdown of targeted radionuclides within the body, and so forth) to acquire data and to construct images or otherwise represent the observed internal features of the patient/object.

These imaging techniques may exhibit various artifacts in the generated images (e.g., rings, bands, streaks, brightness and/or contrast inconsistencies, center artifacts (which may manifest as bright or dark structures at the image center), and so forth). Such artifacts can impact image quality and diagnostic value of the resulting images. These artifacts can be symptomatic of imaging system component (e.g., hardware) issues. For example, in a computed tomography (CT) imaging system context, such artifacts may be indicative of issues related to the X-ray tube, tank, detector, collimator, and so forth or the CT imaging system.

Because artifacts can detract from system performance and impact clinical utility, imaging systems are typically tested under a variety of defined scan conditions to evaluate the existence of these artifacts. Testing generally occurs prior to shipment of a system, upon installation of a system, and/or after routine maintenance of a system. Current test methods are not fully automated and require human intervention, either in the evaluation of the images or in the setup of test conditions (e.g., placement of a test phantom). As a result, such testing approaches may be labor intensive and/or performed less frequently than may be warranted.

### BRIEF DESCRIPTION

In one embodiment, a neural network is provided that is configured to identify serviceable issues related to the operation of an imaging system. In accordance with this embodiment, the neural network comprises: an input layer configured to receive images generated by imaging systems; two or more hidden layers configured to receive the images from the input layer and to generate a respective segmented image for each image, wherein the segmented images comprise at least one segment corresponding to image artifacts; and an output layer configured to provide an output based on the segmented images.

In a further embodiment, a method for diagnosing imaging system issues is provided. In accordance with this embodiment, an image generated by an imaging system is received as an input at an input layer of a trained neural network. The image is processed via one or more layers of the trained neural network. Processing the image comprises at least segmenting the image to derive a segment corresponding to image artifacts. An output based on the segment corresponding to image artifacts is output at an output layer of the trained neural network.

In an additional embodiment, one or more non-transitory computer-readable media encoding processor-executable routines are provided. In accordance with this embodiment, the routines, when executed by a processor, cause acts to be performed comprising: receiving as an input at an input layer of a trained neural network an image generated by an imaging system; processing the image via one or more layers of the trained neural network, wherein processing the image comprises at least segmenting the image to derive a segment corresponding to image artifacts; and outputting at an output layer of the trained neural network an output based on the segment corresponding to image artifacts.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 depicts an example of an artificial neural network for training a deep learning model, in accordance with aspects of the present disclosure;

FIG. 2 is a block diagram depicting components of a computed tomography (CT) imaging system, in accordance with aspects of the present disclosure;

FIG. 3 depicts an example of a process flow related to data used to train, refine, and/or maintain an image artifact identification algorithm, in accordance with aspects of the present disclosure;

FIG. 4 depicts an example of a neural network architecture, in accordance with aspects of the present disclosure;

FIG. 5 depicts an example of a process flow related to servicing imaging equipment, in accordance with aspects of the present disclosure; and

FIG. 6 is a block diagram of a computing device capable of implementing the present approach, in accordance with aspects of the present disclosure.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

While aspects of the following discussion are provided in the context of medical imaging, it should be appreciated that the present techniques are not limited to such medical contexts. Indeed, the provision of examples and explanations in such a medical context is only to facilitate discussion by providing instances of real-world implementations and applications. However, the present approaches may also be utilized in other contexts, such as industrial computed tomography (CT) used in non-destructive inspection of manufactured parts or goods (i.e., quality control or quality review applications), and/or the non-invasive inspection of packages, boxes, luggage, and so forth (i.e., security or screening applications). In general, the present approaches may be useful in any imaging or screening context or image processing field where a reconstructed image may contain artifacts that may be processed as discussed herein to facilitate providing service to an imaging system and/or correction factors that may be employed by an imaging system. Further, though X-ray computed tomography (CT) examples are provided herein, it should be understood that the present approach may be used in other imaging modality contexts where image reconstruction processes may be subject to hardware, firmware, and/or software related artifacts.

As discussed herein, artifacts found in CT images can be symptomatic of CT component (e.g., tube, tank, detector, collimator) issues. Common artifacts observed are rings, bands, streaks, and center artifacts (which typically manifest as bright or dark structures at the image center). Because artifacts can detract from system performance and impact clinical utility, systems are tested under a variety of defined scan conditions to evaluate the existence of these artifacts. Testing occurs prior to shipment of a system, upon installation of a system, and after routine maintenance of a system. Existing test methods are not fully automated and require human intervention either in the evaluation of the images or in the setup of test conditions (e.g., placement of a test phantom). The approach discussed herein addresses these issues by applying deep learning methods (e.g., convolutional neural networks) to automate testing for such artifacts. For example, in one implementation a deep neural network (or other suitable machine learning architecture) may be employed in this process. As may be appreciated, a neural network as discussed herein can be trained for use across multiple types of systems or may be system specific. Further, in some embodiments, such trained networks can use the scan data generated by a respective system with feedback loops as inputs to the trained neural network, which makes the network self-learning in implementation.

In one such embodiment, the trained neural network accepts scan images (e.g., CT images) as an input and outputs a probability map indicating the presence (or absence) of artifacts at the image pixel level. The network may be trained end-to-end with a dataset consisting of simulated and real scan images. For example the training images may have ground truth segmentation annotations or labels. In one embodiment, the network is trained (such as via standard backpropagation of errors) to improve the agreement between the network prediction and the ground truth segmentation. The trained network serves as a robust means to automate screening of CT images for artifacts. This approach can be applied for specific scan conditions or to image data acquired as a part of normal imaging operation, such as a clinical operation.

With the preceding in mind, neural networks as discussed herein may encompass deep neural networks, fully connected networks, convolutional neural networks (CNNs), perceptrons, auto encoders, recurrent networks, wavelet filter banks, or other neural network architectures. These techniques are generally referred to herein as machine learning. As discussed herein, one implementation of machine learning may be deep learning techniques, and such deep learning terminology may also be used specifically in reference to the use of deep neural networks, which is a neural network having a plurality of layers.

As discussed herein, deep learning techniques (which may also be known as deep machine learning, hierarchical learning, or deep structured learning) are a branch of machine learning techniques that employ mathematical representations of data and artificial neural network for learning. By way of example, deep learning approaches may be characterized by their use of one or more algorithms to extract or model high level abstractions of a type of data of interest. This may be accomplished using one or more processing layers, with each layer typically corresponding to a different level of abstraction or a different stage or phase of a process or event and, therefore potentially employing or utilizing different aspects of the initial data or outputs of a preceding layer (i.e., a hierarchy or cascade of layers) as the target of the processes or algorithms of a given layer. In an image processing or reconstruction context, this may be characterized as different layers corresponding to the different feature levels or resolution in the data. In general, the processing from one representation space to the next-level representation space can be considered as one ‘stage’ of the process. Each stage of the reconstruction can be performed by separate neural networks or by different parts of one larger neural network.

As discussed herein, as part of the initial training of deep learning processes to solve a particular problem, such as identification of service issues based on identified artifacts in image data, training data sets may be employed that have known initial values (e.g., input images, projection data, emission data, and so forth) and known or desired values for a final output (e.g., reconstructed tomographic reconstructions, such as cross-sectional images or volumetric representations). The training of a single stage may have known input values corresponding to one representation space and known output values corresponding to a next-level representation space. In this manner, the deep learning algorithms may process (either in a supervised, semi-supervised, or unsupervised manner) the known or training data sets until the mathematical relationships between the initial data and desired output(s) are discerned and/or the mathematical relationships between the inputs and outputs of each layer are discerned and characterized. Similarly, separate validation data sets may be employed in which both the initial and desired target values are known, but only the initial values are supplied to the trained deep learning algorithms, with the outputs then being compared to the outputs of the deep learning algorithm to validate the prior training and/or to prevent over-training.

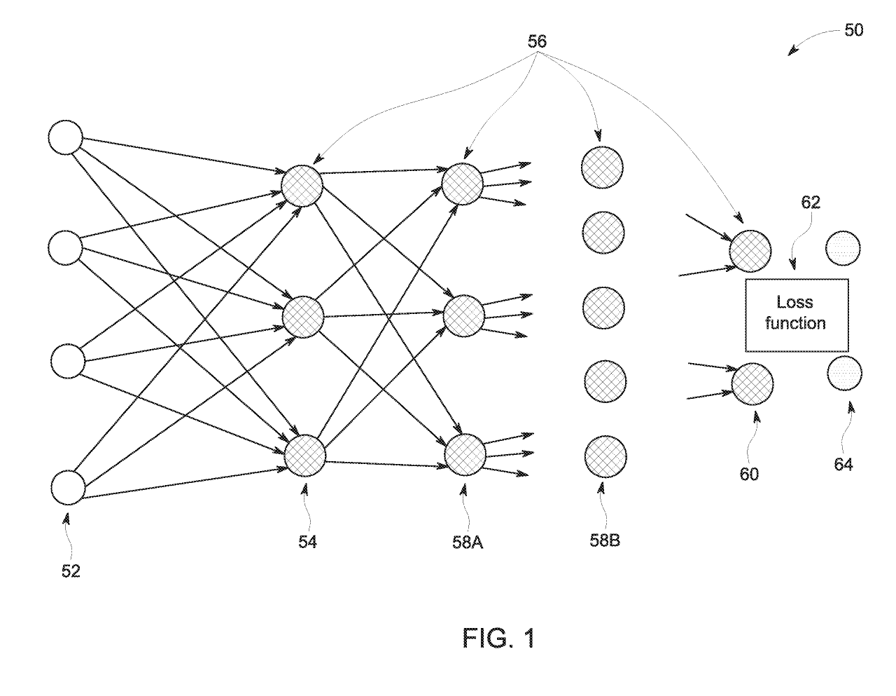

With the preceding in mind, FIG. 1 schematically depicts an example of an artificial neural network 50 that may be trained as a deep learning model as discussed herein. In this example, the network 50 is multi-layered, with a training input 52 and multiple layers including an input layer 54, hidden layers 58A, 58B, and so forth, and an output layer 60 and the training target 64 present in the network 50. Each layer, in this example, is composed of a plurality of “neurons” or nodes 56. The number of neurons 56 may be constant between layers or, as depicted, may vary from layer to layer. Neurons 56 at each layer generate respective outputs that serve as inputs to the neurons 56 of the next hierarchical layer. In practice, a weighted sum of the inputs with an added bias is computed to “excite” or “activate” each respective neuron of the layers according to an activation function, such as rectified linear unit (ReLU), sigmoid function, hyperbolic tangent function, or otherwise specified or programmed. The outputs of the final layer constitute the network output 60 (e.g., one or more convolution kernel parameters, a convolution kernel, and so forth) which, in conjunction with the training target 64, are used to compute some loss or error function 62, which will be backpropagated to guide the network training.

The loss or error function 62 measures the difference between the network output (e.g., a convolution kernel or kernel parameter) and the training target. In certain implementations, the loss function may be a mean squared error (MSE) of the voxel-level values or partial-line-integral values and/or may account for differences involving other image features, such as image gradients or other image statistics. Alternatively, the loss function 62 could be defined by other metrics associated with the particular task in question, such as a softmax function.

In a training example, the neural network 50 may first be constrained to be linear (i.e., by removing all non-linear units) to ensure a good initialization of the network parameters. The neural network 50 may also be pre-trained stage-by-stage using computer simulated input-target data sets, as discussed in greater detail below. After pre-training, the neural network 50 may be trained as a whole and further incorporate non-linear units.

To facilitate explanation of the present image analysis approach using deep learning techniques, the present disclosure discusses these approaches in the context of a CT system. However, it should be understood that the following discussion may also be applicable to other image modalities and systems including, but not limited to, PET, CT, MM, CBCT, PET-CT, PET-MR, C-arm, SPECT, multi-spectral CT, as well as to non-medical contexts or any context where tomographic reconstruction is employed to reconstruct an image.

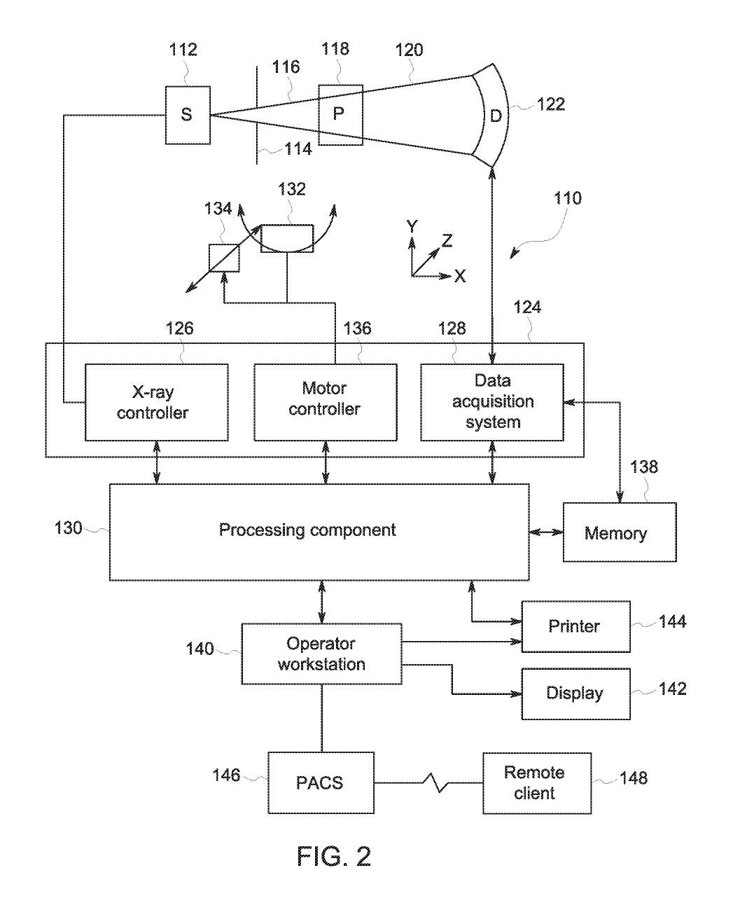

With this in mind, an example of a CT imaging system 110 (i.e., a CT scanner) is depicted in FIG. 2. In the depicted example, the imaging system 110 is designed to acquire scan data (e.g., X-ray attenuation data) at a variety of views around a patient (or other subject or object of interest) and suitable for performing image reconstruction using tomographic reconstruction techniques. In the embodiment illustrated in FIG. 2, imaging system 110 includes a source of X-ray radiation 112 positioned adjacent to a collimator 114. The X-ray source 112 may be an X-ray tube, a distributed X-ray source (such as a solid-state or thermionic X-ray source) or any other source of X-ray radiation suitable for the acquisition of medical or other images.

In the depicted example, the collimator 114 shapes or limits a beam of X-rays 116 that passes into a region in which a patient/object 118, is positioned. In the depicted example, the X-rays 116 are collimated to be a cone-shaped beam, i.e., a cone-beam, that passes through the imaged volume. A portion of the X-ray radiation 120 passes through or around the patient/object 118 (or other subject of interest) and impacts a detector array, represented generally at reference numeral 122. Detector elements of the array produce electrical signals that represent the intensity of the incident X-rays 120. These signals are acquired and processed to reconstruct images of the features within the patient/object 118.

Source 112 is controlled by a system controller 124, which furnishes both power, and control signals for CT examination sequences, including acquisition of two-dimensional localizer or scout images used to identify anatomy of interest within the patient/object for subsequent scan protocols. In the depicted embodiment, the system controller 124 controls the source 112 via an X-ray controller 126 which may be a component of the system controller 124. In such an embodiment, the X-ray controller 126 may be configured to provide power and timing signals to the X-ray source 112.

Moreover, the detector 122 is coupled to the system controller 124, which controls acquisition of the signals generated in the detector 122. In the depicted embodiment, the system controller 124 acquires the signals generated by the detector using a data acquisition system 128. The data acquisition system 128 receives data collected by readout electronics of the detector 122. The data acquisition system 128 may receive sampled analog signals from the detector 122 and convert the data to digital signals for subsequent processing by a processor 130 discussed below. Alternatively, in other embodiments the digital-to-analog conversion may be performed by circuitry provided on the detector 122 itself. The system controller 124 may also execute various signal processing and filtration functions with regard to the acquired image signals, such as for initial adjustment of dynamic ranges, interleaving of digital image data, and so forth.

In the embodiment illustrated in FIG. 2, system controller 124 is coupled to a rotational subsystem 132 and a linear positioning subsystem 134. The rotational subsystem 132 enables the X-ray source 112, collimator 114 and the detector 122 to be rotated one or multiple turns around the patient/object 118, such as rotated primarily in an x,y-plane about the patient. It should be noted that the rotational subsystem 132 might include a gantry or C-arm upon which the respective X-ray emission and detection components are disposed. Thus, in such an embodiment, the system controller 124 may be utilized to operate the gantry or C-arm.

The linear positioning subsystem 134 may enable the patient/object 118, or more specifically a table supporting the patient, to be displaced within the bore of the CT system 110, such as in the z-direction relative to rotation of the gantry. Thus, the table may be linearly moved (in a continuous or step-wise fashion) within the gantry to generate images of particular areas of the patient 118. In the depicted embodiment, the system controller 124 controls the movement of the rotational subsystem 132 and/or the linear positioning subsystem 134 via a motor controller 136.

In general, system controller 124 commands operation of the imaging system 110 (such as via the operation of the source 112, detector 122, and positioning systems described above) to execute examination protocols and to process acquired data. For example, the system controller 124, via the systems and controllers noted above, may rotate a gantry supporting the source 112 and detector 122 about a subject of interest so that X-ray attenuation data may be obtained at one or more views relative to the subject. In the present context, system controller 124 may also include signal processing circuitry, associated memory circuitry for storing programs and routines executed by the computer (such as routines for analyzing images for service indications as described herein), as well as configuration parameters, image data, and so forth.

In the depicted embodiment, the image signals acquired and processed by the system controller 124 are provided to a processing component 130 for reconstruction of images. The processing component 130 may be one or more general or application-specific microprocessors. The data collected by the data acquisition system 128 may be transmitted to the processing component 130 directly or after storage in a memory 138. Any type of memory suitable for storing data might be utilized by such an exemplary system 110. For example, the memory 138 may include one or more optical, magnetic, and/or solid state memory storage structures. Moreover, the memory 138 may be located at the acquisition system site and/or may include remote storage devices for storing data, processing parameters, and/or routines for tomographic image reconstruction and analysis, as described below.

The processing component 130 may be configured to receive commands and scanning parameters from an operator via an operator workstation 140, typically equipped with a keyboard and/or other input devices. An operator may control the system 110 via the operator workstation 140. Thus, the operator may observe the reconstructed images and/or otherwise operate the system 110 using the operator workstation 140. For example, a display 142 coupled to the operator workstation 140 may be utilized to observe the reconstructed images and to control imaging. Additionally, the images may also be printed by a printer 144 which may be coupled to the operator workstation 140.

Further, the processing component 130 and operator workstation 140 may be coupled to other output devices, which may include standard or special purpose computer monitors and associated processing circuitry. One or more operator workstations 140 may be further linked in the system for outputting system parameters, requesting examinations, viewing images, and so forth. In general, displays, printers, workstations, and similar devices supplied within the system may be local to the data acquisition components, or may be remote from these components, such as elsewhere within an institution or hospital, or in an entirely different location, linked to the image acquisition system via one or more configurable networks, such as the Internet, virtual private networks, and so forth.

It should be further noted that the operator workstation 140 may also be coupled to a picture archiving and communications system (PACS) 146. PACS 146 may in turn be coupled to a remote client 148, radiology department information system (RIS), hospital information system (HIS) or to an internal or external network, so that others at different locations may gain access to the raw or processed image data.

While the preceding discussion has treated the various exemplary components of the imaging system 110 separately, these various components may be provided within a common platform or in interconnected platforms. For example, the processing component 130, memory 138, and operator workstation 140 may be provided collectively as a general or special purpose computer or workstation configured to operate in accordance with the aspects of the present disclosure. In such embodiments, the general or special purpose computer may be provided as a separate component with respect to the data acquisition components of the system 110 or may be provided in a common platform with such components. Likewise, the system controller 124 may be provided as part of such a computer or workstation or as part of a separate system dedicated to image acquisition.

As may be appreciated from the preceding description, the imaging system 110 includes a variety of components that if not functioning properly may result in an observable effect (e.g., an artifact) in images generated using the imaging system 110. By way of example, deterioration or malfunction of an X-ray source 112 (e.g., an X-ray tube) or its underlying components, a collimator, an anti-scatter grid, or the detector array 122 may result in image artifacts, such as streaks, rings, bands, and so forth. In addition, problems associated with electrical or signal processing aspects of the imaging system 110, such as the detector readout circuitry, pre-processing circuitry, and/or A/D conversion circuitry may result in some form of visible artifacts in a generated image. As discussed herein, a trained algorithm may be employed to identify one or more likely hardware or electronic sources of observed artifacts and to recommend or plan a service operation on the imaging system 110 based this identification. As discussed herein, the present approach may be suitable for use both with deployed systems at client sites as well as for systems in a manufacturing or pre-deployment context, where it may be desirable to have a system diagnosed and serviced prior or deployment at a client site. In such a context, it may even be useful in identifying persistent or recurring issues that may be indicative of a problem occurring in the manufacturing or initial quality control level. Further, as the present approach may be valuable in both pre- and post-deployment contexts, it may be beneficial (as discussed in greater detail below) to utilize data generated in both contexts to train and refine the machine learning algorithms discussed herein for analyzing artifacts and diagnosing issues.

Further, as noted above the training of the machine learning algorithm may employ any suitable data set and use a suitable training approach (e.g., supervised (i.e., completely labeled training data), unsupervised (i.e., all unlabeled training data), or semi-supervised learning (i.e., a mix of labeled and unlabeled training data)). In certain examples discussed herein, a semi-supervised learning approach is discussed in particular, and such an approach may offer benefits that are useful in certain implementations. In particular, such semi-supervised learning approaches allow the use of unlabeled data sets to supplement a limited amount of labeled data as part of the training process, which can greatly increase the amount of data available for training while decreasing or eliminating the time otherwise needed to label the training data. Such semi-supervised learning approaches, by utilizing both labeled and unlabeled training data, may improve upon the classification performance that obtained by discarding unlabeled data and performing only supervised learning or by discarding labels and doing only unsupervised learning.

In the present context, the labeled data used to train the algorithm may consist of individual pixels or pixel aggregates (e.g., image structures, such as contiguous structures) being labeled or otherwise classified as background, artifact, or phantom/tissue. As noted above, labeling of an image in this manner is labor and time intensive. The unlabeled data, conversely, has no labeling or classification of pixel or pixel aggregates, and is not labor or time intensive to prepare. Such unlabeled images may be generated synthetically, such as using a generative adversarial network (GAN), may be generated as part of a calibration or quality control process by imaging a phantom, or may be a diagnostic or clinical image generated in use. The semi-supervised learning process of the trained algorithm, in this context, may learn image structures (e.g., the appearance of certain artifacts, phantom structures, tissue structures, or background) from the unlabeled images and may learn the labels of such structures from the labeled images. In this manner, a large image data set may be available for training or refining the algorithm, though only a limited number of those images may be labeled. The resulting classification algorithm is trained to classify pixels or structures within a presented image as background, artifact or artifact type, and phantom/tissue.

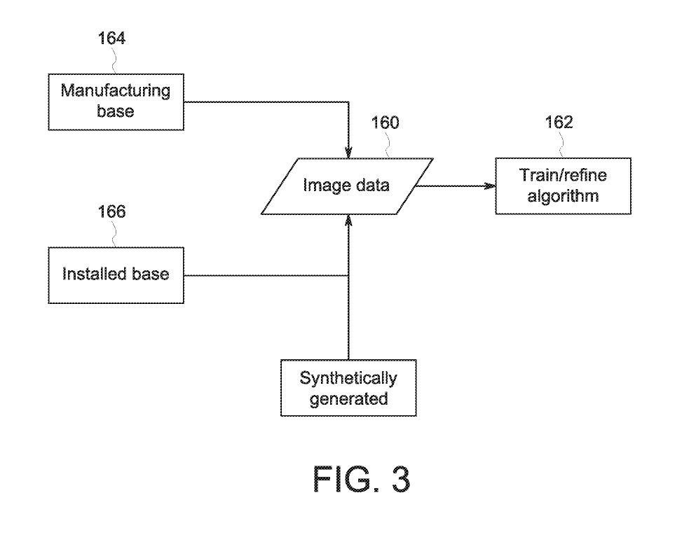

As shown in FIG. 3, in practice, the image data 160 used to train and/or refine the machine learning algorithm (block 162) may be derived from multiple sources, including a manufacturing base 164 and a deployed or installed base 166. In addition, some portion of the training data may be synthetically generated, such as using a GAN as noted above. By allowing the model to be refined over time using data from both the installed and manufacturing base, certain benefits can be achieved including improved performance of the model. Further, this approach allows the model to adapt to how the performance of the respective imaging systems changes over time (i.e., as the fleet of systems ages and/or degrades), to changes in the manufacturing process that may affect the performance of the imaging systems and/or the manner in which a type of artifact manifests in systems manufactured using new parts or processes, and/or to newer version of the imaging systems as they are manufactured and become part of the installed base.

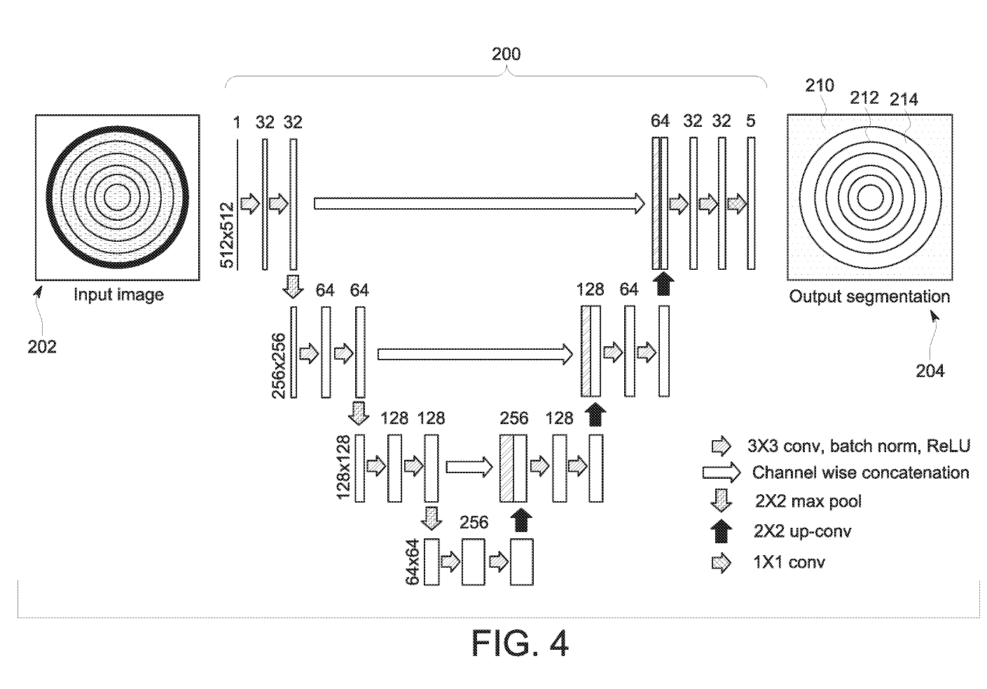

Turning from the training of a machine learning algorithm, to the implementation of such an algorithm, FIG. 4 depicts an example of a neural network architecture suitable for use in accordance with the present approach. In the depicted example, the neural network architecture is provided as a U-net style deep neural network architecture 200 trained to accept an input image 202 (here a phantom image exhibiting ring artifacts) and to generate an output segmentation 204 (here a segmented image in which pixels are labeled and/or displayed as either background 210, artifact 212, or tissue/phantom 214). In this example, the progressive layers or levels of the neural network initially convolve (here using 3×3 convolutions) and downsample the input image 202 before subsequent layers or levels upsample the image to generate the output segmentation. In the process, the initial single channel (here a grey-scale channel) is increases to three channels (here, a different color channel for each labeled segment).

As may be appreciated, though this is one example of a suitable neural network architecture, other neural network or machine learning configurations may also be trained to perform the depicted operations. Likewise, the depicted architecture may be used to process images in a pixel-wise (i.e., pixel-by-pixel) or image-wise (e.g., full image or segmented image structures) manner to delineate and identify artifacts.

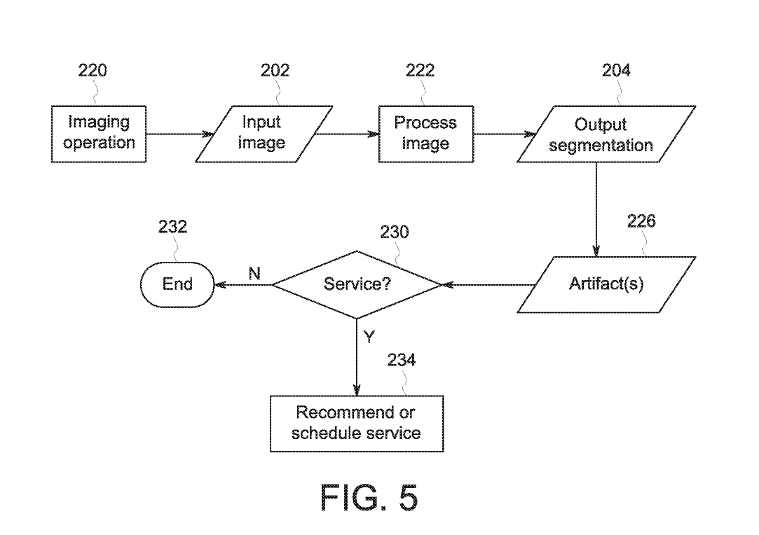

With respect to the use of a trained artifact identification and classification algorithm as discussed herein, as noted above one such use is to facilitate the recommendation or scheduling of service events (e.g., service calls) for an imaging system based on artifacts observed in the images. By way of example, and turning to FIG. 5, in one process flow imaging operations 220 performed by an imaging system generates images that may be submitted as input images 202 to a trained algorithm as discussed herein. As noted above, the imaging operation 220 may be performed at an imaging system installed at a client site as part of a clinical scan or calibration procedure or at a manufacturing facility as part of a quality review or calibration process.

In the depicted example, the input image(s) 202 is processed (block 222) as discussed herein to generate an output segmentation image 204. In the output image, artifacts 226, if present, are identified and characterized. In certain aspects, such an artifact characterization may be singular (i.e., an artifact 226 is identified as being of a singular type) or may be probabilistic (i.e., an artifact 226 is identified and characterized as having associated probabilities of corresponding to different types or artifacts or combinations of artifact types). Likewise, the severity of the artifact 226 may be characterized.

The characterization of the artifact 226 in terms of type, severity, and probabilistic confidence may be factors that are then used in an automated determination (block 230) as to whether the respective imaging system requires a service operation or not (block 232). In the event that a service operation is determined to be appropriate, a service event may be automatically recommended or scheduled (block 234) by the analysis system. As may be appreciated, a service event used herein may encompass replacement or upgrading of a hardware component, but also encompasses firmware and/or software updates or reconfiguration, calibration of one or more aspects of the imaging system, application of software or processing correction of identified issues (e.g., bad pixels, contrast or brightness irregularities, and so forth), as well as other corrective measures that may be taken in view of an identified artifact appearing in images generated by a respective imaging system. Further, the present approach may allow for the scheduling of preventive or proactive service calls by early recognition of a hardware failure event, which reduces or eliminates reactive service calls occurring in response to system failure and that are associated with additional or unscheduled system downtime. As with artifact characterization, prescribed service operations may also be provided in a probabilistic or ranked sense, such as based upon their likelihood of addressing or resolving an observed artifact issue.

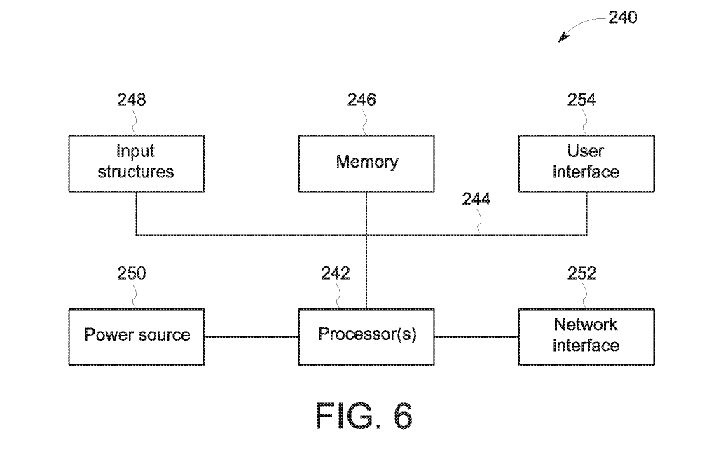

As will be appreciated, some or all of the approach discussed herein related to artifact identification and characterization using trained deep neural networks and subsequent automated service event evaluation and recommendation may be performed or otherwise implemented using a processor-based system such as shown in FIG. 6 or several such systems in communication with one another. Such a system may include some or all of the computer components depicted in FIG. 6. FIG. 6 generally illustrates a block diagram of example components of a computing device 240 and their potential interconnections or communication paths, such as along one or more busses. As used herein, a computing device 240 may be implemented as one or more computing systems including laptop, notebook, desktop, tablet, or workstation computers, as well as server type devices or portable, communication type devices, and/or other suitable computing devices.

As illustrated, the computing device 240 may include various hardware components, such as one or more processors 242, one or more busses 244, memory 246, input structures 248, a power source 250, a network interface 252, a user interface 254, and/or other computer components useful in performing the functions described herein.

The one or more processors 242 are, in certain implementations, microprocessors configured to execute instructions stored in the memory 246 or other accessible locations. Alternatively, the one or more processors 242 may be implemented as application-specific integrated circuits (ASICs), field-programmable gate arrays (FPGAs), and/or other devices designed to perform functions discussed herein in a dedicated manner. As will be appreciated, multiple processors 242 or processing components may be used to perform functions discussed herein in a distributed or parallel manner.

The memory 246 may encompass any tangible, non-transitory medium for storing data or executable routines, including volatile memory, non-volatile memory, or any combination thereof. Although shown for convenience as a single block in FIG. 6, the memory 246 may actually encompass various discrete media in the same or different physical locations. The one or more processors 242 may access data in the memory 246 via one or more busses 244.

The input structures 248 are used to allow a user to input data and/or commands to the device 240 and may include mice, touchpads, touchscreens, keyboards, and so forth. The power source 250 can be any suitable source for providing power to the various components of the computing device 240, including line and battery power. In the depicted example, the device 240 includes a network interface 252. Such a network interface 252 may allow communication with other devices on a network using one or more communication protocols. In the depicted example, the device 240 includes a user interface 254, such as a display configured to display images or date provided by the one or more processors 242.

Technical effects of the invention include machine learning-based detection of image artifacts symptomatic of needed calibration and/or failing hardware with no or limited human intervention. The machine learning-based detection of image artifacts can occur as part of normal imaging system operation and/or as part of a quality assessment of a newly manufactured of already installed system. The machine learning-based detection of image artifacts can adapt or learn as new scans are acquired using supervised or semi-supervised learning. In this manner assessment of system imaging performance in the recently manufactured as well as the installed base can be performed reliably and automatically.

The present approach allows for assessment of system service needs during normal operation (as opposed to during calibration operations) and does not require system downtime. This approach also facilitates early detection of service issues, and thereby facilitates proactive service actions, reducing unscheduled or unplanned system downtime. The present approach also is faster and more robust that corresponding user assessment of image artifacts (i.e., manual evaluation), such as in a manufacturing context.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A neural network configured to identify serviceable issues related to the operation of an imaging system, the neural network comprising:
an input layer configured to receive images generated by imaging systems;
two or more hidden layers configured to receive the images from the input layer and to generate a respective segmented image for each image, wherein the segmented images comprise at least one segment corresponding to image artifacts; and
an output layer configured to provide an output based on the segmented images.

2. The neural network of claim 1, wherein the output comprises an indication of a hardware or system component issue related to an image artifact identified in a respective segmented image.

3. The neural network of claim 1 wherein the output comprises a ranked list of service operations based on their likelihood of resolving an identified image artifact issue.

4. The neural network of claim 1, wherein the output comprises a probability assessment of the types of artifacts present in a corresponding input image.

5. The neural network of claim 1, wherein the output comprises a service call recommendation or appointment in response to an image artifact identified in a respective segmented image.

6. The neural network of claim 1, wherein the respective segmented images are segmented into background, tissue or phantom, and artifacts.

7. The neural network of claim 1, comprising training or refining the neural network using semi-supervised learning, wherein an image data set used for semi-supervised learning is derived from both an installed-based of imaging systems and a manufacturing base of imaging systems.

8. The neural network of claim 1, wherein the images received by the input layer are derived from both an installed-based of imaging systems and a manufacturing base of imaging systems.

9. A method for diagnosing imaging system issues, comprising:
receiving as an input at an input layer of a trained neural network an image generated by an imaging system;
processing the image via one or more layers of the trained neural network, wherein processing the image comprises at least segmenting the image to derive a segment corresponding to image artifacts; and
outputting at an output layer of the trained neural network an output based on the segment corresponding to image artifacts.

10. The method of claim 9, wherein the imaging system is installed at a customer site or is undergoing evaluation after manufacture but prior to installation.

11. The method of claim 9, wherein the output comprises an indication of a hardware or system component issue related to an image artifact identified in the segment corresponding to image artifacts.

12. The method of claim 9, wherein the output comprises a ranked list of service operations based on their likelihood of resolving an image artifact identified in the segment corresponding to image artifacts.

13. The method of claim 9, wherein the output comprises a probability assessment of the types of artifacts present in the image.

14. The method of claim 9, wherein the output comprises a service call recommendation or appointment in response to an image artifact identified in the segment corresponding to image artifacts.

15. The method of claim 9, wherein processing the image comprises segmenting the image into background, tissue or phantom, and artifact segments.

16. The method of claim 9, comprising refining the training neural network over time using semi-supervised learning, wherein training images used for semi-supervised learning are derived from both an installed-based of imaging systems and a manufacturing base of imaging systems.

17. One or more non-transitory computer-readable media encoding processor-executable routines, wherein the routines, when executed by a processor, cause acts to be performed comprising:
receiving as an input at an input layer of a trained neural network an image generated by an imaging system;
processing the image via one or more layers of the trained neural network, wherein processing the image comprises at least segmenting the image to derive a segment corresponding to image artifacts; and
outputting at an output layer of the trained neural network an output based on the segment corresponding to image artifacts.

18. The one or more non-transitory computer-readable media of claim 17, wherein the output comprises an indication of a hardware or system component issue related to an image artifact identified in the segment corresponding to image artifacts.

19. The one or more non-transitory computer-readable media of claim 17, wherein the output comprises a ranked list of service operations based on their likelihood of resolving an image artifact identified in the segment corresponding to image artifacts.

20. The one or more non-transitory computer-readable media of claim 17, wherein the output comprises a service call recommendation or appointment in response to an image artifact identified in the segment corresponding to image artifacts.
